(19) United States
(12) Patent Application Publication
(10) Pub. No.: US 2026/0066936 A1
(43) Pub. Date: Mar. 5, 2026

(54) MOUNTING DEVICE FOR MOBILE TERMINAL AND READING APPARATUS HAVING THE SAME

(71) Applicant: BLUEBIRD INC., Seoul (KR)

(72) Inventors: Yong Woon KIM, Incheon (KR); Dae Hoon KIM, Goyang-si (KR)

(21) Appl. No.: 19/312,213

(22) Filed: Aug. 27, 2025

(30) Foreign Application Priority Data
Aug. 30, 2024 (KR) 10-2024-0117662

(51) Int. Cl. H04B 1/3877; G06K 7/10; H04M 1/04

(52) U.S. Cl. CPC H04B 1/3877; G06K 7/10386; G06K 7/10881; H04M 1/04; G06K 2007/10524

(57) ABSTRACT

A mounting device for a mobile terminal and a reading apparatus having the mounting device for a mobile terminal are disclosed. The mounting device for a mobile terminal according to an embodiment includes a mounting case to which a mobile terminal is detachably coupled, and a detachable pogo module manufactured in a module type, detachably coupled to the mounting case, and electrically connected to the mobile terminal when the mobile terminal is coupled to the mounting case.

### CROSS-REFERENCE TO RELATED PATENT APPLICATIONS

This application claims the benefit of Korean Patent Application No. 10-2024-0117662, filed on Aug. 30, 2024, in the Korean Intellectual Property Office, the disclosure of which is incorporated herein in its entirety by reference.

### BACKGROUND

### 1. Field

The disclosure relates to a mounting device for a mobile terminal and a reading apparatus having the mounting device for a mobile terminal, and more particularly, to a mounting device for a mobile terminal, which may enable consumers to directly replace broken pogo pins only, thereby significantly reducing cost or time loss that may occur when a pogo pin is broken, and a reading apparatus having the mounting device.

### 2. Description of the Related Art

Mobile terminals are terminals that can be used freely while moving around without being restricted by location, and representative examples include mobile communication terminals such as mobile phones or personal digital assistants (PDAs) which are known as personal portable terminals. Accordingly, the term ‘mobile terminal’ used herein includes all of the above-described terminals, but in the following description, for convenience of explanation, the explanation will be limited to the PDA.

In a society that is becoming more complex and diverse, each individual has a need to store or maintain information in his or her own way. To meet these individual needs, various products are currently being released on the market, one of which is the PDA.

The PDA, also called a pocket computer, is a general term for a small, palm-sized device with calculation, information storage, and information search functions for personal or business use, and is often used to maintain schedule calendars, address book information, or the like.

In particular, industrial PDAs are currently being widely used, especially in the logistics industry, and their market is gradually expanding.

An industrial PDA is a PDA equipped with various office functions, such as a barcode scanner or a card reader, that are not found in general PDAs. Using an industrial PDA has the advantage of being able to efficiently carry out tasks, such as delivery, data management, or related work.

For example, in the case of insurance companies, various insurance-related tasks, such as customer information management, customer search, schedule management, consultation log management, anniversary search, or financial statement processing, can be handled directly on site by insurance planers using industrial PDAs. Next, in the hospital, patient's medical records and medical history or prescriptions, as well as video images such as X-rays and graphic data can be input or searched for using the industrial PDA carried by the medical staff without limitation of time and place. Furthermore, in terms of police work, as police officers conduct field crackdowns for traffic and crime prevention through industrial PDAs, fines for traffic violations, which currently require 2-3 days to be paid, can be immediately paid to financial institutions, remarkably shortening the time for field crackdowns for traffic and crime prevention by police officers.

Meanwhile, while these PDAs may be used alone, the PDAs are also used by being coupled to, that is mounted on, a mounting device. The mounting device supports the PDA and has a plurality of pogo pins for electrical connection to the PDA. The pogo pins supply power and other electrical connections to the PDA.

However, in the case of an existing mounting device for a mobile terminal, the existing mounting device is of a type in which pogo pins electrically connected to a mobile terminal, for example, a PDA, are integrally fixed to a mounting case, and thus when the pogo pins break, it may result in cost loss as the entire mounting device for a mobile terminal need to be replaced.

Even when repair (A/S) is possible depending on whether a pogo pin is broken, the existing mounting device for a mobile terminal has structural limitations that make it difficult for consumers to work on the mounting device directly. Accordingly, considering that the mounting device needs to be sent to a corresponding manufacturer for repair, time loss is inevitable, and thus a need for technology development to solve this issue arises.

### SUMMARY

Provided are a mounting device for a mobile terminal, which enables consumers to directly replace broken pogo pins only, thereby significantly reducing cost or time loss that may occur when a pogo pin is broken, and a reading apparatus having the mounting device for a mobile terminal.

According to an aspect of the disclosure, a mounting device for a mobile terminal includes a mounting case to which a mobile terminal is detachably coupled, and a detachable pogo module manufactured in a module type, detachably coupled to the mounting case, and electrically connected to the mobile terminal when the mobile terminal is coupled to the mounting case.

The mounting case may include a bottom case forming a bottom and including a plurality of terminal mounting wing portions supporting the mobile terminal to be mounted thereon, and a middle case connected to the bottom case and including a module detachable coupling portion to which the detachable pogo module is detachably coupled.

A flexible printed circuit board (FPCB) including a plurality of pin terminals for electric connection to the detachable pogo module may be provided on the bottom case.

The module detachable coupling portion may include a module through portion formed by penetrating the middle case to expose the plurality of pin terminals of the FPCB to outside.

The module detachable coupling portion may further include a plurality of case hook portions provided along an inner peripheral surface of the module through portion and coupled to the detachable pogo module in a hook type, and a catch support portion provided on a surface of the inner peripheral surface of the module through portion in which the case hook portion is not formed, and on which the detachable pogo module is caught and supported.

The module detachable coupling portion may further include a module separation groove provided at one side of an entrance area of the module through portion and forming a place for separating the detachable pogo module coupled to the module detachable coupling portion.

The module detachable coupling portion may further include a pair of protruding stoppers provided to protrude from both sides of the entrance area of the module through portion and supporting the detachable pogo module coupled to the module detachable coupling portion on both sides.

The detachable pogo module may include a plurality of pogo pins having end portions selectively electrically connected to pin terminals of the FPCB, a pin supporting block selectively arranged in the module through portion area and supporting the pogo pins, and a plurality of module hook portions provided on one side of the pin supporting block and caught by the case hook portion in a hook type when the detachable pogo module is coupled to the module detachable coupling portion.

The detachable pogo module may further include a catch rib provided on another side of the pin supporting block and caught by the catch support portion when the detachable pogo module is coupled to the module detachable coupling portion.

The mobile terminal may include a personal digital assistant (PDA).

According to another aspect of the disclosure, a reading apparatus includes a mounting device for a mobile terminal, to which a mobile terminal is detachably coupled, and an information reading apparatus detachably connected to the mounting device for a mobile terminal and reading information, wherein the mounting device for a mobile terminal includes a mounting case to which a mobile terminal is detachably coupled, and a detachable pogo module manufactured in a module type, detachably coupled to the mounting case, and electrically connected to the mobile terminal when the mobile terminal is coupled to the mounting case.

The mounting case may include a bottom case forming a bottom and including a plurality of terminal mounting wing portions supporting the mobile terminal to be mounted thereon, and a middle case connected to the bottom case and including a module detachable coupling portion to which the detachable pogo module is detachably coupled.

An FPCB including a plurality of pin terminals for electric connection to the detachable pogo module may be provided on the bottom case.

The module detachable coupling portion may include a module through portion formed by penetrating the middle case to expose the plurality of pin terminals of the FPCB to outside, a plurality of case hook portions provided along an inner peripheral surface of the module through portion and coupled to the detachable pogo module in a hook type, a catch support portion provided on a surface of the inner peripheral surface of the module through portion where the case hook portion is not formed, and on which the detachable pogo module is caught and supported, a module separation groove provided at one side of an entrance area of the module through portion and forming a place for separating the detachable pogo module coupled to the module detachable coupling portion, and a pair of protruding stoppers provided to protrude from both sides of the entrance area of the module through portion and supporting the detachable pogo module coupled to the module detachable coupling portion on both sides.

The detachable pogo module may include a plurality of pogo pins having end portions selectively electrically connected to pin terminals of the FPCB, a pin supporting block selectively arranged in the module through portion area and supporting the pogo pins, a plurality of module hook portions provided on one side of the pin supporting block and caught by the case hook portion in a hook type when the detachable pogo module is coupled to the module detachable coupling portion, and a catch rib provided on another side of the pin supporting block and caught by the catch support portion when the detachable pogo module is coupled to the module detachable coupling portion.

The information reading apparatus may include a radio frequency identification (RFID) information reading apparatus that reads information through RFID technology.

The RFID information reading apparatus may include a reading apparatus main body connected to the mounting device for a mobile terminal on one side, and an RFID read portion forming a front surface of the reading apparatus main body and including an RFID module arranged adjacent to an RFID tag to be read and reading the information within the RFID tag.

The RFID information reading apparatus may further include a grip portion coupled to the reading apparatus main body at a back side of the RFID read portion and including a switch for selectively turning on/off an operation of the RFID module.

The information reading apparatus may further include a controller controls, based on the operation of the switch operation, such that the information within the RFID tag read by the RFID module is output to the mobile terminal control.

The mobile terminal may include a PDA.

### BRIEF DESCRIPTION OF THE DRAWINGS

Exemplary embodiments of the disclosure will be more clearly understood from the following detailed description taken in conjunction with the accompanying drawings in which:

Exemplary embodiments of the disclosure will be more clearly understood from the following detailed description taken in conjunction with the accompanying drawings in which:

FIG. 1 is a view showing that a mobile terminal is coupled to a mounting device for a mobile terminal, according to an embodiment;

FIG. 2 is a perspective view of a reading apparatus including a mounting device for a mobile terminal, according to an embodiment;

FIGS. 3 and 4 are views showing FIG. 2 at different angles;

FIG. 5 is a perspective view of a mounting device for a mobile terminal, according to an embodiment;

FIG. 6 is a view showing FIG. 5 at a different angle;

FIG. 7 is a view showing that a detachable pogo module is separated in FIG. 5;

FIG. 8 is a view showing that a mounting case is separated in FIG. 7;

FIG. 9 is a perspective view of a detachable pogo module;

FIGS. 10 and 11 are views showing FIG. 9 at different angles;

FIG. 12 is an enlarged view of a region A of FIG. 8;

FIGS. 13 and 14 are views showing FIG. 12 at different angles; and

FIG. 15 is a control block diagram of a reading apparatus including a mounting device for a mobile terminal, according to an embodiment.

### DETAILED DESCRIPTION OF THE EXEMPLARY EMBODIMENTS

Embodiments of the disclosure are described in detail with reference to the accompanying drawings. However, the disclosure is not limited thereto and it will be understood that various changes in form and details may be made therein without departing from the spirit and scope of the following claims. That is, descriptions on particular structures or functions may be presented merely for explaining embodiments of the disclosure.

As the disclosure allows for various changes and numerous embodiments, embodiments will be illustrated in the drawings and described in detail in the written description. Throughout the drawings, like reference numerals denote like elements.

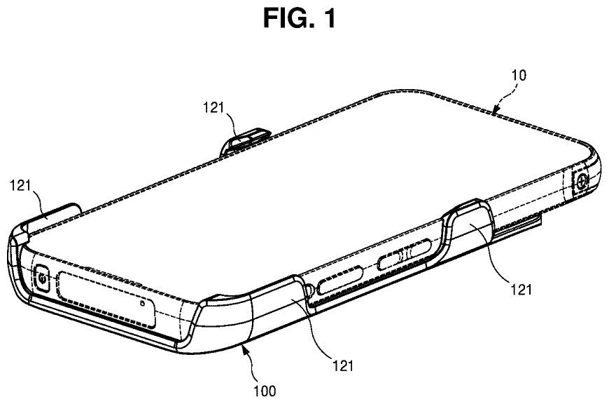

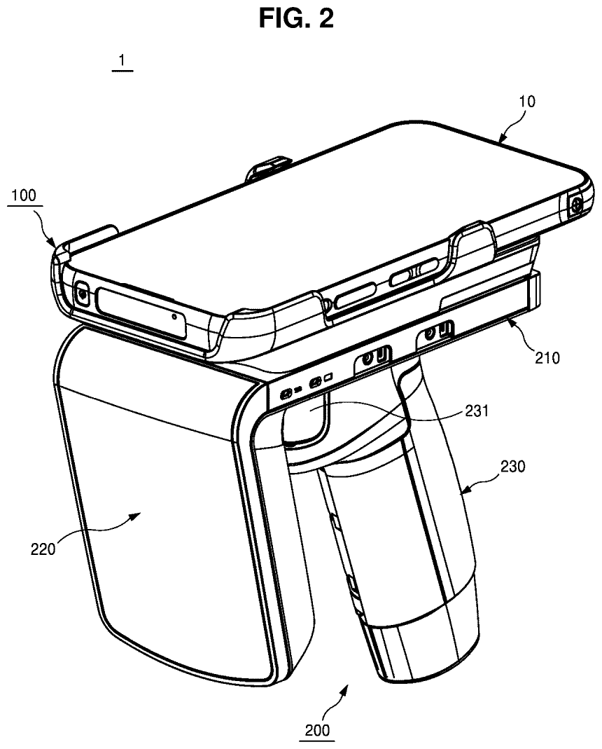

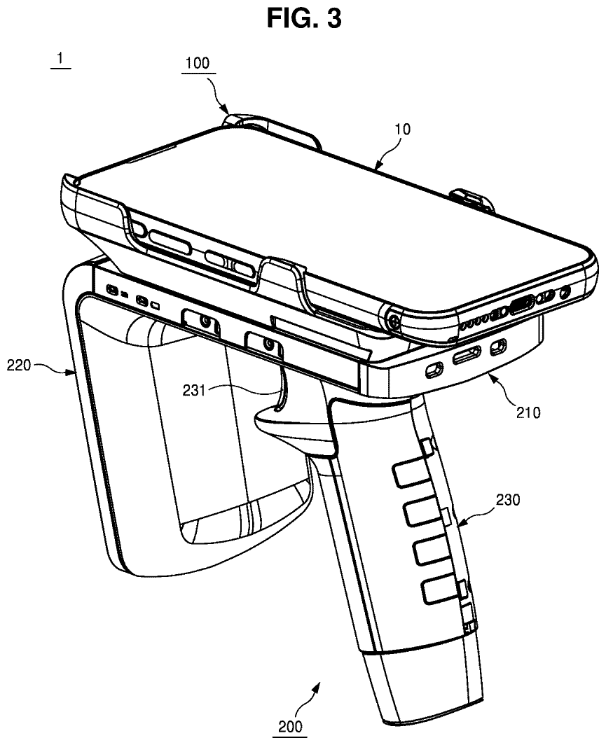

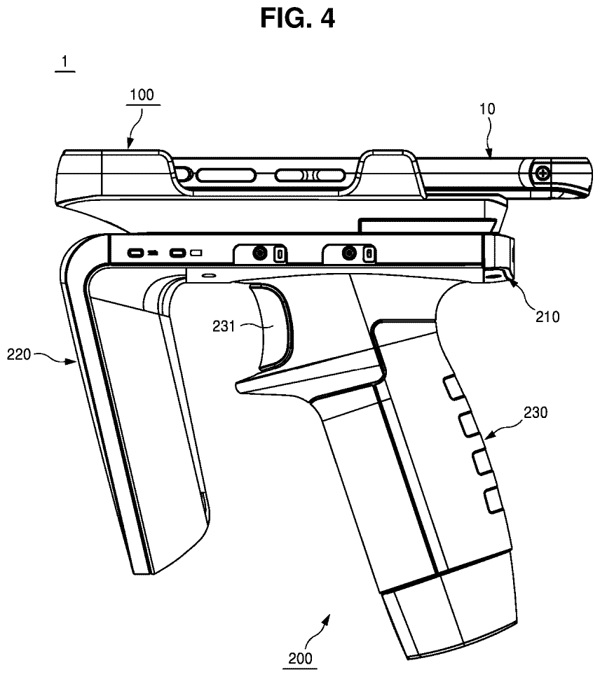

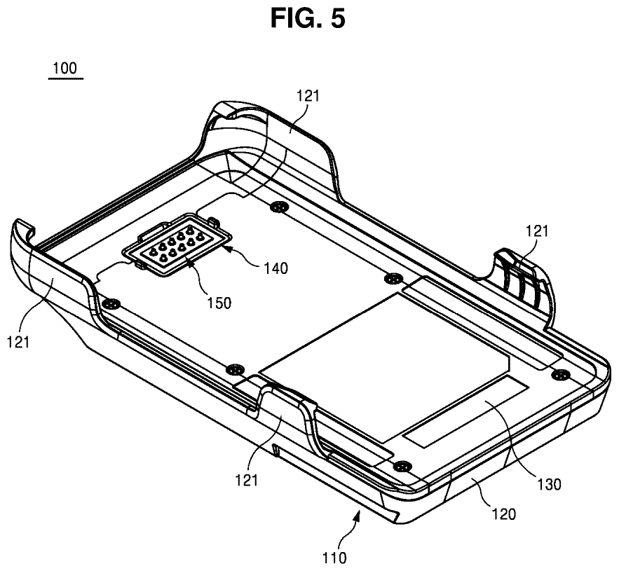

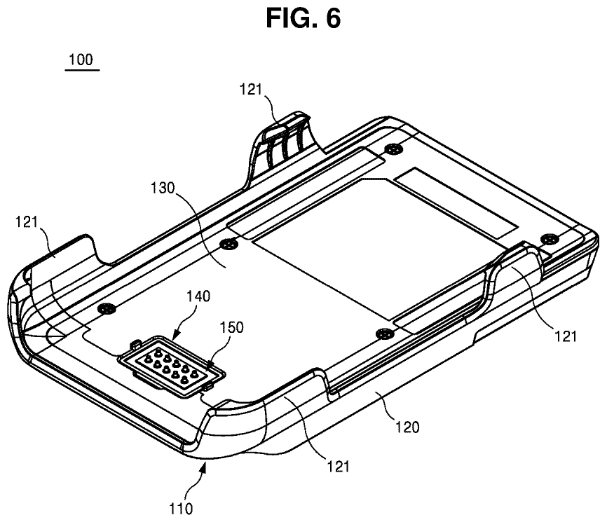

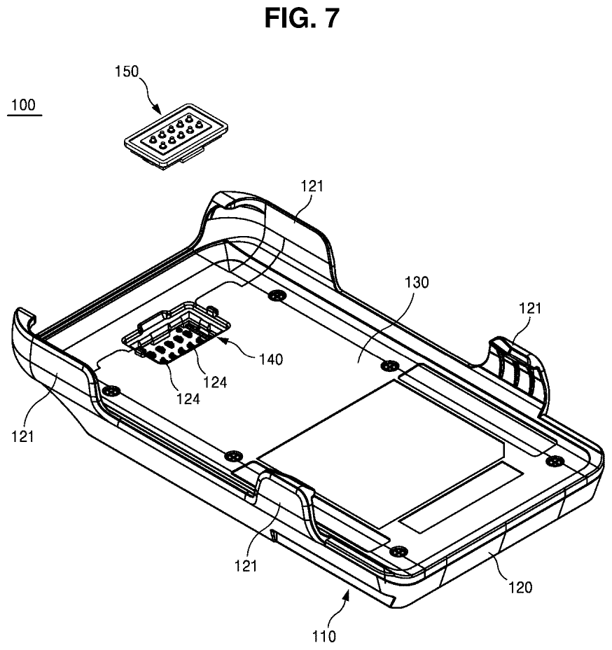

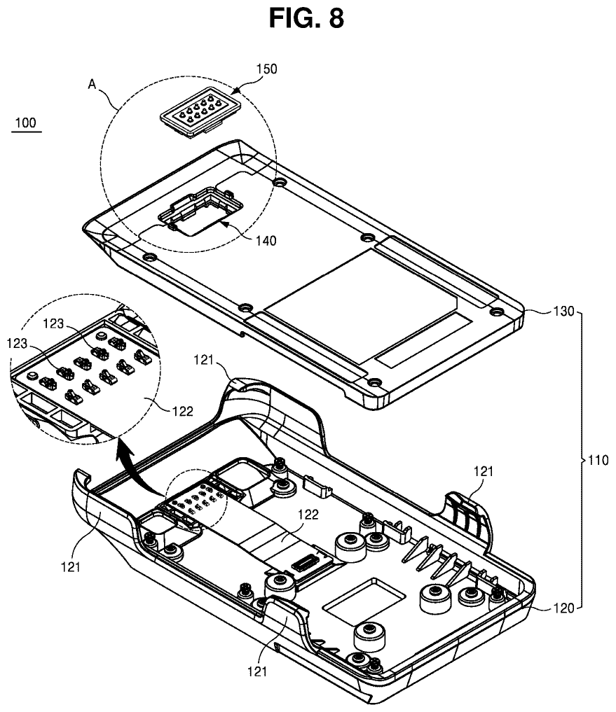

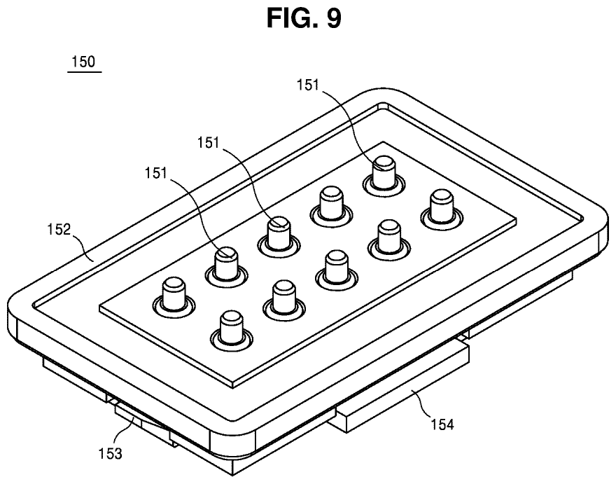

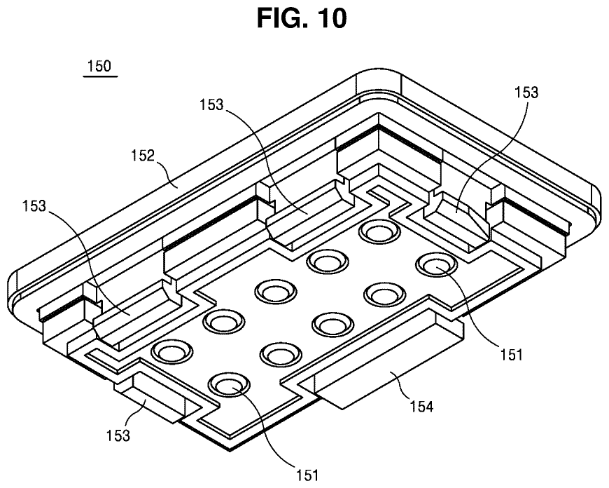

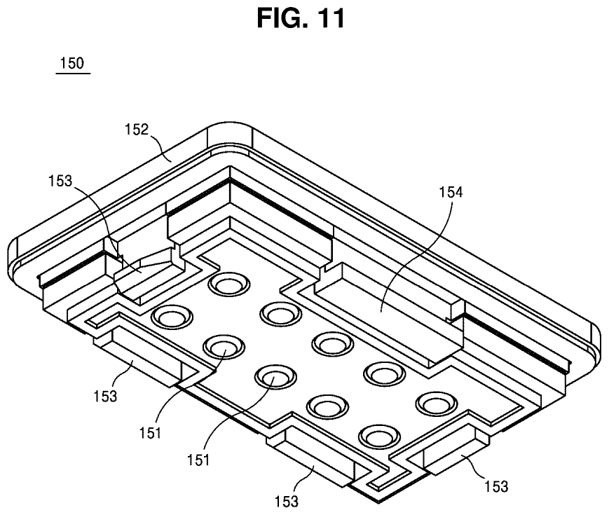

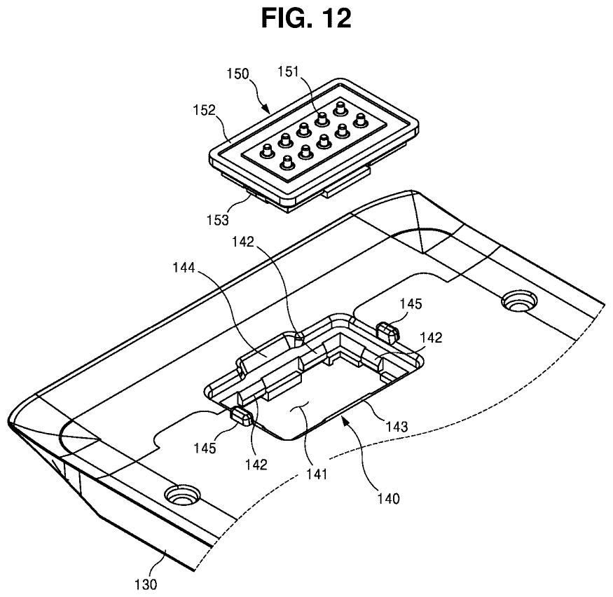

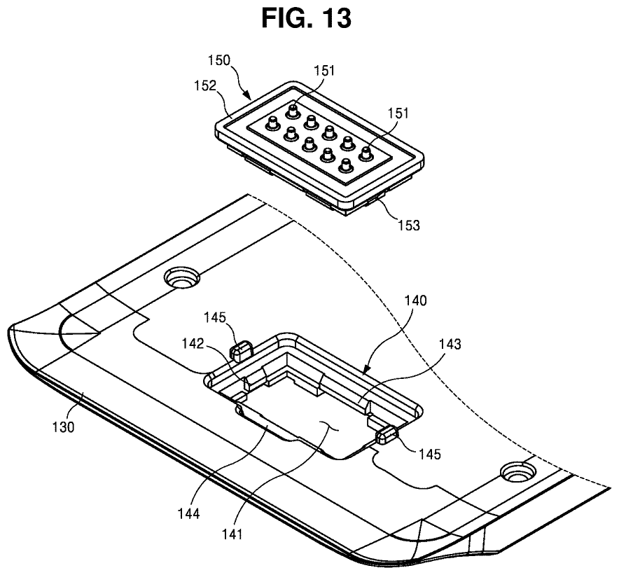

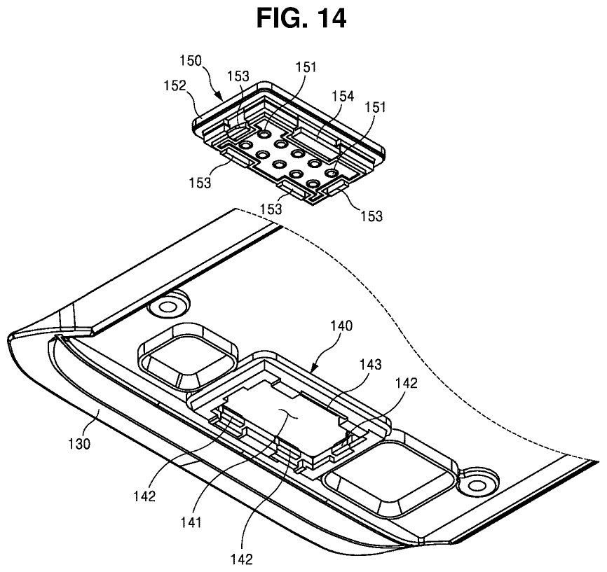

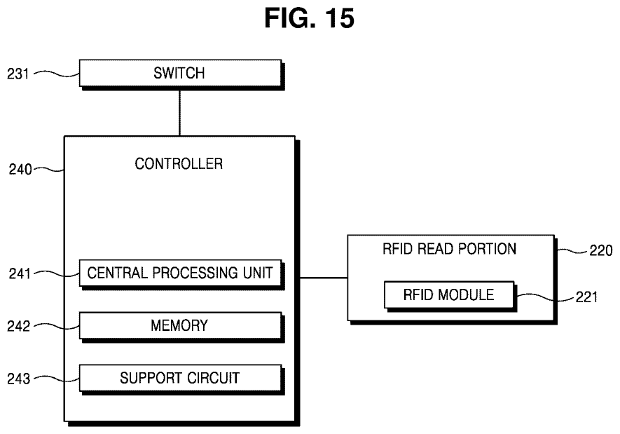

FIG. 1 is a view showing that a mobile terminal is coupled to a mounting device for a mobile terminal, according to an embodiment. FIG. 2 is a perspective view of a reading apparatus including a mounting device for a mobile terminal, according to an embodiment. FIGS. 3 and 4 are views showing FIG. 2 at different angles. FIG. 5 is a perspective view of a mounting device for a mobile terminal, according to an embodiment. FIG. 6 is a view showing FIG. 5 at a different angle. FIG. 7 is a view showing that a detachable pogo module is separated in FIG. 5. FIG. 8 is a view showing that a mounting case is separated in FIG. 7. FIG. 9 is a perspective view of a detachable pogo module. FIGS. 10 and 11 are views showing FIG. 9 at different angles. FIG. 12 is an enlarged view of a region A of FIG. 8. FIGS. 13 and 14 are views showing FIG. 12 at different angles. FIG. 15 is a control block diagram of a reading apparatus including a mounting device for a mobile terminal, according to an embodiment.

Referring to these drawings, according to the disclosure, as consumers may directly replace only a pogo pin 151 that is broken, cost or time loss that may occur when the pogo pin 151 is broken may be significantly reduced.

The disclosure which may provide such an effect may have the scope of right applied to the mounting device 100 for a mobile terminal as illustrated in FIGS. 1 and 5 to 8, and a reading apparatus 1 including the mounting device 100 for a mobile terminal as illustrated in FIGS. 2 to 4.

In other words, according to the disclosure, as illustrated in FIG. 1, the mobile terminal 10 may be mounted for use on the mounting device 100 for a mobile terminal, and as illustrated in FIGS. 2 to 4, after the mobile terminal 10 is mounted on the mounting device 100 for a mobile terminal, an information reading apparatus 200 is further connected to the mounting device 100 for a mobile terminal so as to be used as one reading apparatus 1. Accordingly, the scope of right of the disclosure may be applied to both of the mounting device 100 for a mobile terminal and the reading apparatus 1.

First, the mounting device 100 for a mobile terminal is described. The mobile terminal 10 is detachably coupled to the mounting device 100 for a mobile terminal, as illustrated in FIGS. 1 and 5 to 14.

As described above, the mobile terminal 10 is a terminal that may be freely used while moving around without being restricted by location, and typically includes a mobile communication terminal such as a mobile phone and a personal digital assistant (PDA) called a personal portable terminal. Accordingly, although the term ‘mobile terminal’ includes all of the above terminals, in the following description, for convenience of explanation, the PDA is mainly described. In other words, in the following description, the mobile terminal 10 and a PDA 10 are interchangeably used.

The mounting device 100 for a mobile terminal, according to the present embodiment may include a mounting case 110 and a detachable pogo module 150 that is manufactured in a module type, is detachably coupled to the mounting case 110, and when the mobile terminal 10 is coupled to the mounting case 110, is electrically connectable to the mobile terminal 10.

The mounting case 110 is an electromechanical structure to which the mobile terminal 10, for example, the PDA 10, is detachably coupled. The mounting case 110 may be divided into a bottom case 120 and a middle case 130.

The bottom case 120 forms the bottom surface of the mounting case 110. The bottom case 120 is used as a portion that is detachably connected to a reading apparatus main body 210 of the information reading apparatus 200 to be described below.

A terminal mounting wing portion 121 is formed on the bottom case 120 to support the PDA 10 to be detachably mounted thereon. The terminal mounting wing portion 121 is formed at a side portion of the bottom case 120 in an arc-shaped wing type, and includes a plurality of terminal mounting wing portions. Accordingly, when the PDA 10 is coupled to the mounting case 110, the PDA 10 does not easily escape from the mounting case 110.

The bottom case 120 is provided with a flexible printed circuit board (FPCB) 122. The FPCB 122 is a mother substrate of a circuit board coated with a copper foil that is flexibly bent. Although a 3-layer structure of a copper foil and a polyimide (PI) film coupled to each other using an adhesive has been mainly used, a 2-layer FCCL product in which a PI film is directly die-casted onto a copper foil or attached with a high temperature is released. The 2-layer FCCL that is easy to form a fine pattern and has excellent flexibility is widely used for mobile phone holders or display products such as LCD or PDP modules.

A plurality of pin terminals 123 are formed on the FPCB 122. When the detachable pogo module 150 is coupled to the FPCB 122, the pin terminals 123 are electrically connected to the pogo pins 151 of the detachable pogo module 150 to transceive, for example, battery power or various signals from the side of the information reading apparatus 200 to the PDA 10.

The middle case 130 is a case connected to the bottom case 120. Screws or bosses are provided between the middle case 130 and the bottom case 120 so that the middle case 130 and the bottom case 120 may be detachably connected to each other. As the middle case 130 and the bottom case 120 are detachably connected to each other, maintenance and repair of parts therebetween, for example, the FPCB 122, is possible.

A module detachable coupling portion 140 to which the detachable pogo module 150 is substantially detachably coupled is provided in the middle case 130. The module detachable coupling portion 140 may include a module through portion 141, a case hook portion 142, a catch support portion 143, a module separation groove 144, and a protruding stopper 145.

The module through portion 141 is a kind of hole formed by penetrating the middle case 130. The module through portion 141 has a rectangular hole shape so that the detachable pogo module 150 may be detachably coupled thereto.

As the module through portion 141 is formed, the pin terminals 123 on the FPCB 122 mounted on the bottom case 120 may be exposed to the outside, and when the detachable pogo module 150 is coupled to the module detachable coupling portion 140, the pogo pins 151 may be electrically connected to the pin terminals 123.

The case hook portion 142 is provided along an inner peripheral surface of the module through portion 141 and hook-coupled to a module hook portion 153 of the detachable pogo module 150. The case hook portion 142 may include a plurality of case hook portions formed along the inner peripheral surface of the module through portion 141. In order for the module hook portions 153 of the detachable pogo module 150 to be easily hook-coupled to the case hook portions 142, end portions of the case hook portions 142 are processed to have an inclined shape.

The catch support portion 143 is provided on a portion of the inner peripheral surface of the module through portion 141 in which the case hook portion 142 is not formed, and is a portion where a catch rib 154 of the detachable pogo module 150 is caught and supported. In order to form a strong interlocking force, the catch support portion 143 has a larger surface than the case hook portion 142. Also, it may be possible to adopt the case hook portion 142 only without the catch support portion 143. It should be understood that all the above cases fall within the scope of right of the disclosure.

The module separation groove 144 is provided at one side of an entrance area of the module through portion 141, and forms a place for separating the detachable pogo module 150 coupled to the module detachable coupling portion 140. In other words, when the pogo pin 151 of the detachable pogo module 150 is broken or a problem occurs in a contact point, the detachable pogo module 150 is replaced with a new one. In this state, the detachable pogo module 150 is separated by inserting a screw driver, a coin, a nail, or the like into the module separation groove 144.

The protruding stopper 145 is a protruding structure that protrudes from both sides of the entrance area of the module through portion 141. The protruding stopper 145 supports the detachable pogo module 150 coupled to the module detachable coupling portion 140 from both sides. Accordingly, the protruding stopper 145 is provided as a pair on both sides of the module through portion 141.

The detachable pogo module 150 is detachably coupled to the module detachable coupling portion 140 of the mounting case 110, and when the PDA 10 is coupled to the mounting case 110, the detachable pogo module 150 is electrically connected to the PDA 10.

As the detachable pogo module 150 is manufactured as a module type as described above, the detachable pogo module 150 may be separately purchased. Accordingly, when the pogo pin 151 of the detachable pogo module 150 is broken or a problem occurs in the contact point, the detachable pogo module 150 is replaced with a new one. As a replacement work can be performed directly by consumers, unlike the related art, cost or time loss that may occur when the pogo pin 151 is broken may be significantly reduced.

The detachable pogo module 150 may include the pogo pin 151, a pin supporting block 152, the module hook portion 153, and the catch rib 154.

When the detachable pogo module 150 is coupled to the module detachable coupling portion 140 of the mounting case 110, an end portion of the pogo pin 151 is selectively electrically connected to the pin terminals 123 of the FPCB 122. The front surface of the pogo pin 151 is electrically connected to the PDA 10. Although ten pogo pins 151 are illustrated in the drawings, the number of the pogo pins 151 is not limited thereto.

The pin supporting block 152 is a structure that is selectively arranged in an area of the module through portion 141 and supports the pogo pins 151. The pin supporting block 152 may be integrally injected through insert of the pogo pins 151.

The module hook portion 153 is provided on one side of the pin supporting block 152, and when the detachable pogo module 150 is coupled to the module detachable coupling portion 140, the module hook portion 153 is a portion that is caught in a hook type by the case hook portion 142 of the module detachable coupling portion 140. The module hook portion 153 may include a plurality of module hook portions. As described above, the case hook portion 142 of the module detachable coupling portion 140 is provided along the inner peripheral surface of the module through portion 141, and the module hook portion 153 of the detachable pogo module 150 may be coupled to the case hook portion 142 in a hook type.

The catch rib 154 is provided on the other side of the pin supporting block 152, and when the detachable pogo module 150 is coupled to the module detachable coupling portion 140, the catch rib 154 is a portion that is caught by the catch support portion 143 of the module detachable coupling portion 140. As described above, the catch rib 154 is not necessarily formed, but when the catch rib 154 is provided and the catch rib 154 is caught by the catch support portion 143 of the module detachable coupling portion 140, more solid fastening force may be induced.

Next, the reading apparatus 1 is described with reference to FIGS. 2 to 4. As described above, according to the disclosure, as illustrated in FIG. 1, the mobile terminal 10 may be mounted for use on the mounting device 100 for a mobile terminal, and as illustrated in FIGS. 2 to 4, after the mobile terminal 10 is mounted on the mounting device 100 for a mobile terminal, the information reading apparatus 200 is further connected to the mounting device 100 for a mobile terminal so as to be used as one reading apparatus 1.

The information reading apparatus 200 in this state reads information, and in the case of the present embodiment, the information reading apparatus 200 is the RFID information reading apparatus 200 that reads information by using radio frequency identification (RFID) technology.

For reference, the RFID is a general term for technology that processes information about objects using small semiconductor chips. The RFID is a contactless identification system that attaches small chips to various objects and transmits and processes information about the object and a surrounding environment via wireless frequency.

A radio identification system including a reader with a reading and decoding function, an RF tag (RF ID tag) with unique information embedded therein, operating software, and a network processes information by identifying a thin, flat tag attached to an object.

The RF tag includes a semiconductor-based transponder chip and an antenna, and may be either passive or active. While passive tags operate, without internal power, with energy from the reader's radio signal, active tags have a built-in RF tag battery for self-operation. The RF tags are also categorized as chip tags, which use silicon semiconductor chips, and chip-less tags, which solely include LC elements, plastic, or polymer elements.

Radio frequency identification technology, unlike barcodes, does not require direct contact or scanning within the visible band. Because of these advantages, the radio frequency identification technology is being evaluated as a replacement for barcodes, and the scope of application is expanding. Low-frequency radio frequency identification systems (30 kHz to 500 kHz) are used over short distances of 1.8 m or less, while high-frequency systems (850 MHz to 950 MHz or 2.4 GHz to 2.5 GHz) are known to be capable of transmitting over distances of 27 m or more.

As the RFID technology facilitates the implementation of various management systems, including process management, asset management, logistics management, inventory management, access security, location tracking, and cultural heritage management, research on RFID reading devices utilizing RFID technology has been actively conducted in recent years, and various products are already being released. Currently available RFID reading devices range from portable RFID reading devices with their functions built into industrial PDAs to fixed RFID reading devices that are fixed to a table and used, and the scope of application is also expanding.

However, embedding the functions of an RFID reading device into a PDA would inevitably result in a substantially larger PDA, potentially inconvenient for users seeking only simple PDA functionality. Conversely, fixed RFID reading devices are not portable so that the fixed RDID reading devices may be difficult to use except in limited locations.

Accordingly, in the present embodiment, considering that the PDA 10 is widely used throughout the industry, the reading apparatus 1 that can be equipped and used with the PDA 10 is proposed.

The reading apparatus 1 may refer to, as illustrated above in FIGS. 2 to 4, a series of devices in which after the mobile terminal 10 is mounted on the mounting device 100 for a mobile terminal, The RFID information reading apparatus 200 is further connected to the mounting device 100 for a mobile terminal.

The RFID information reading apparatus 200 includes the reading apparatus main body 210, and a RFID read portion 220, a grip portion 230, and a controller 240 are mounted on the reading apparatus main body 210 by location.

The reading apparatus main body 210, as an exterior structure of the RFID information reading apparatus 200, supports the RFID read portion 220, the grip portion 230, or the like. The mounting device 100 for a mobile terminal may be detachably coupled to the reading apparatus main body 210 at one side, that is, an upper surface, of the reading apparatus main body 210, through a detachable method using a screw or a hook.

The RFID read portion 220 forms the front surface of the reading apparatus main body 210. The RFID read portion 220 includes an RFID module 221 that is arranged adjacent to an RFID tag (not shown) to be read and reads information within the RFID tag. For example, assuming that, in a clothing store, RFID tags are attached to a large number of clothes, when the RFID read portion 220 is placed around the RFID tags attached to the clothes, the RFID module 221 in the RFID read portion 220 reads the information within the RFID tags.

The grip portion 230 is a portion coupled to the reading apparatus main body 210 at the back side of the RFID read portion 220, and is used as a handle that a user grips. A switch 231 for selectively turning on/off the operation of the RFID module 221 is provided at the grip portion 230. The grip portion 230 is of a gun type, and while holding the grip portion 230 and pressing the switch 231 with the index finger, the information within the RFID tag may be read through the RFID module 221.

The controller 240 controls the information within the RFID tag read by the RFID module 221 to be output to the PDA 10 that is the mobile terminal 10, based on the operation of the switch 231. The controller 240 that performing the above function may include a central processing unit (CPU) 241, a memory 242, and a support circuit 243.

The CPU 241 may be one of various computer processors that are industrially used to control the information within the RFID tag read by the RFID module 221 to be output to the PDA 10 that is the mobile terminal 10, based on the operation of the switch 231 in the present embodiment.

The memory 242 is connected to the CPU 241. The memory 242 may be installed locally or remotely as a computer-readable recording medium, and may be at least one memory that is easily usable, for example, random access memory (RAM), read-only memory (ROM), a floppy disk, a hard disk, or a certain digital storage form.

The support circuit 243 is coupled to the CPU 241 and supports a typical operation of a processor. The support circuit 243 may include cache, a power supply, a clock circuit, an input/output circuit, a sub-system, or the like.

In the present embodiment, the controller 240 controls, based on the operation of the switch 231, such that the information within the RFID tag read by the RFID module 221 is output to the PDA 10 that is the mobile terminal 10, and such a series of control processes may be stored in the memory 242. Typically, a software routine may be stored in the memory 242. The software routine may also be stored or executed by another central processing unit (not shown).

Although the process according to the disclosure is described as being performed by a software routine, at least some of processes of the disclosure may be performed by hardware. As such, the process of the disclosure may be implemented by software running on a computer system, hardware such as an integrated circuit, or a combination of software and hardware.

According to the above configuration, as illustrated in FIG. 1, the mobile terminal 10 may be mounted for use on the mounting device 100 for a mobile terminal, and as illustrated in FIGS. 2 to 4, after the mobile terminal 10 is mounted on the mounting device 100 for a mobile terminal, the information reading apparatus 200 is further connected to the mounting device 100 for a mobile terminal so as to be used as one reading apparatus 1.

Meanwhile, when it is determined that, during use, the pogo pin 151 of the detachable pogo module 150 is broken or a problem occurs in the contact point, the corresponding detachable pogo module 150 is separated from the device and replaced with a new one. As described above, as the detachable pogo module 150 is manufactured in a module type as described above, the detachable pogo module 150 may be separately purchased. Thus, as the replacement work of the detachable pogo module 150 can be performed directly by consumers, unlike the related art, cost or time loss that may occur when the pogo pin 151 is broken may be significantly reduced.

According to the embodiments of the disclosure, as consumers may replace directly broken pogo pins only, cost or time loss that may occur when a pogo pin is broken may be significantly reduced.

As such, while this disclosure has been particularly shown and described with reference to embodiments thereof, it will be understood by those of ordinary skill in the art that various changes in form and details may be made therein without departing from the spirit and scope of the disclosure as defined by the appended claims.

The embodiments should be considered in descriptive sense only and not for purposes of limitation. Therefore, the scope of the disclosure is defined not by the detailed description of the disclosure but by the appended claims, and all differences within the scope will be construed as being included in the disclosure.

What is claimed is:

1. A mounting device for a mobile terminal, the mounting device comprising:
a mounting case to which a mobile terminal is detachably coupled; and
a detachable pogo module manufactured in a module type, detachably coupled to the mounting case, and electrically connected to the mobile terminal when the mobile terminal is coupled to the mounting case.

2. The mounting device of claim 1, wherein the mounting case comprises:
a bottom case forming a bottom and including a plurality of terminal mounting wing portions supporting the mobile terminal to be mounted thereon; and
a middle case connected to the bottom case and including a module detachable coupling portion to which the detachable pogo module is detachably coupled.

3. The mounting device of claim 2, wherein a flexible printed circuit board (FPCB) including a plurality of pin terminals for electric connection to the detachable pogo module is provided on the bottom case.

4. The mounting device of claim 3, wherein the module detachable coupling portion comprises a module through portion formed by penetrating the middle case to expose the plurality of pin terminals of the FPCB to outside.

5. The mounting device of claim 4, wherein the module detachable coupling portion further comprises:
a plurality of case hook portions provided along an inner peripheral surface of the module through portion and coupled to the detachable pogo module in a hook type; and
a catch support portion provided on a surface of the inner peripheral surface of the module through portion in which the case hook portion is not formed, and on which the detachable pogo module is caught and supported.

6. The mounting device of claim 4, wherein the module detachable coupling portion further comprises a module separation groove provided at one side of an entrance area of the module through portion and forming a place for separating the detachable pogo module coupled to the module detachable coupling portion.

7. The mounting device of claim 4, wherein the module detachable coupling portion further comprises a pair of protruding stoppers provided to protrude from both sides of the entrance area of the module through portion and supporting the detachable pogo module coupled to the module detachable coupling portion on both sides.

8. The mounting device of claim 4, wherein the detachable pogo module comprises:
a plurality of pogo pins having end portions selectively electrically connected to pin terminals of the FPCB;
a pin supporting block selectively arranged in the module through portion area and supporting the pogo pins; and
a plurality of module hook portions provided on one side of the pin supporting block and caught by the case hook portion in a hook type when the detachable pogo module is coupled to the module detachable coupling portion.

9. The mounting device of claim 8, wherein the detachable pogo module further comprises a catch rib provided on another side of the pin supporting block and caught by the catch support portion when the detachable pogo module is coupled to the module detachable coupling portion.

10. The mounting device of claim 1, wherein the mobile terminal comprises a personal digital assistant (PDA).

11. A reading apparatus comprising:
a mounting device for a mobile terminal, to which a mobile terminal is detachably coupled; and
an information reading apparatus detachably connected to the mounting device for a mobile terminal and reading information,
wherein the mounting device for a mobile terminal comprises:
a mounting case to which a mobile terminal is detachably coupled; and
a detachable pogo module manufactured in a module type, detachably coupled to the mounting case, and electrically connected to the mobile terminal when the mobile terminal is coupled to the mounting case.

12. The reading apparatus of claim 11, wherein the mounting case comprises:
a bottom case forming a bottom and including a plurality of terminal mounting wing portions supporting the mobile terminal to be mounted thereon; and
a middle case connected to the bottom case and including a module detachable coupling portion to which the detachable pogo module is detachably coupled.

13. The reading apparatus of claim 12, wherein a flexible printed circuit board (FPCB) including a plurality of pin terminals for electric connection to the detachable pogo module is provided on the bottom case.

14. The reading apparatus of claim 13, wherein the module detachable coupling portion comprises:
a module through portion formed by penetrating the middle case to expose the plurality of pin terminals of the FPCB to outside;
a plurality of case hook portions provided along an inner peripheral surface of the module through portion and coupled to the detachable pogo module in a hook type;
a catch support portion provided on a surface of the inner peripheral surface of the module through portion where the case hook portion is not formed, and on which the detachable pogo module is caught and supported;
a module separation groove provided at one side of an entrance area of the module through portion and forming a place for separating the detachable pogo module coupled to the module detachable coupling portion; and
a pair of protruding stoppers provided to protrude from both sides of the entrance area of the module through portion and supporting the detachable pogo module coupled to the module detachable coupling portion on both sides.

15. The reading apparatus of claim 14, wherein the detachable pogo module comprises:
a plurality of pogo pins having end portions selectively electrically connected to pin terminals of the FPCB;
a pin supporting block selectively arranged in the module through portion area and supporting the pogo pins;
a plurality of module hook portions provided on one side of the pin supporting block and caught by the case hook portion in a hook type when the detachable pogo module is coupled to the module detachable coupling portion; and
a catch rib provided on another side of the pin supporting block and caught by the catch support portion when the detachable pogo module is coupled to the module detachable coupling portion.

16. The reading apparatus of claim 11, wherein the information reading apparatus comprises a radio frequency identification (RFID) information reading apparatus that reads information through RFID technology.

17. The reading apparatus of claim 16, wherein the RFID information reading apparatus comprises:
a reading apparatus main body connected to the mounting device for a mobile terminal on one side; and
an RFID read portion forming a front surface of the reading apparatus main body and including an RFID module arranged adjacent to an RFID tag to be read and reading the information within the RFID tag.

18. The reading apparatus of claim 17, wherein the RFID information reading apparatus further comprises a grip portion coupled to the reading apparatus main body at a back side of the RFID read portion and including a switch for selectively turning on/off an operation of the RFID module.

19. The reading apparatus of claim 18, wherein the information reading apparatus further comprises a controller controls, based on the operation of the switch operation, such that the information within the RFID tag read by the RFID module is output to the mobile terminal control.

20. The reading apparatus of claim 11, wherein the mobile terminal comprises a personal digital assistant (PDA).
